(19) United States
(12) Patent Application Publication
(10) Pub. No.: US 2026/0005569 A1
(43) Pub. Date: Jan. 1, 2026

(54) STATOR FOR AN AFPM MOTOR AND A MOTOR COMPRISING THE SAME

(71) Applicants: HYUNDAI MOTOR COMPANY, Seoul (KR); KIA CORPORATION, Seoul (KR)

(72) Inventors: Dong Hee Lee, Hwaseong-si (KR); Sang Jin Park, Hwaseong-si (KR); Ji Yeon Kim, Hwaseong-si (KR)

(73) Assignees: HYUNDAI MOTOR COMPANY, Seoul (KR); KIA CORPORATION, Seoul (KR)

(21) Appl. No.: 18/954,196

(22) Filed: Nov. 20, 2024

(30) Foreign Application Priority Data
Jun. 28, 2024 (KR) 10-2024-0085709

(51) Int. Cl. H02K 3/28; H02K 1/16; H02K 15/04; H02K 21/24

(52) U.S. Cl. CPC H02K 3/28; H02K 1/16; H02K 15/0433; H02K 21/24

(57) ABSTRACT

A stator for an axial flux permanent magnet motor and a motor including the same are disclosed. The stator may include a stator core configured to include a predetermined number of slots in a circumferential direction and a plurality of coils configured to be inserted into the predetermined number of slots and connected to the phases of a multi-phase power supply source. The coil may be coupled to the stator core by an odd-layer winding and an even-layer winding that rotate to form a multi-helical structure so that the odd-layer winding and the even-layer winding may be coupled to the stator core in the multi-helical structure. Thus, the height of end-turns may be shortened and the diameter of the stator may be increased.

### CROSS-REFERENCE TO RELATED APPLICATIONS

The present application claims priority to Korean Patent Application No. 10-2024-0085709, filed on Jun. 28, 2024, the entire contents of which are incorporated herein for all purposes by this reference.

### TECHNICAL FIELD

The present disclosure relates to a stator for an axial flux permanent magnet (AFPM) motor and a motor including the same, and, more particularly, to a stator for the same where odd-layer and even-layer windings may be combined to a stator core in a multi-helical structure.

### BACKGROUND

The statements in this section merely provide background information related to the present disclosure and may not constitute prior art.

Korean Patent Application Publication Nos. 10-2021-0120081 and 10-2021-0120082 disclose an axial flux permanent magnet (AFPM) motor, where an end-turn of a coil is formed in a semicircle in a radial direction. In the case of such a motor, the height of the end-turn increases depending on the height of a winding so that the radial height of the end-turn increases. This increases the diameter of a housing and thus increasing the size of the motor.

The information included in this Background section is only to enhance understanding of the general background of the present disclosure. Therefore, the Background section may not be taken as an acknowledgement or any form of suggestion that this information forms the prior art already known to a person of ordinary skill in the art.

### SUMMARY

The present disclosure provides a stator for an axial flux permanent magnet (AFPM) motor to which a novel winding method is applied and provides a motor including the stator.

The present disclosure also provides a stator for an AFPM motor and a motor including the stator, where it may be possible to reduce the size of the AFPM motor by reducing the height of the end-turn.

In addition, the present disclosure provides a stator for an AFPM motor and a motor including the stator, where it may be possible to improve the electromagnetic performance of the motor by increasing the designable diameter of the stator.

A stator for an AFPM motor according to the present disclosure is disclosed. The stator may include a stator core including a predetermined number of slots in a circumferential direction and may a plurality of coils inserted into the predetermined number of slots and connected to a multi-phase power supply source. The plurality of coils may include odd-layer windings and even-layer windings. Each winding of the odd-layer windings and the even-layer windings are wound along the circumferential direction with end-turns thereof alternately disposed at inner and outer sides of the stator core. Thus, the plurality of coils forms a multi-helical structure.

In a stator for an AFPM motor according to the present disclosure, the plurality of coils may be made of copper material.

In a stator for an AFPM motor according to the present disclosure, the odd-layer windings and the even-layer windings may be in an identical shape and arranged such that end-turns thereof alternate.

In a stator for an AFPM motor according to the present disclosure, each of the odd-layer windings and the even-layer windings may be formed to be in a helical structure.

In a stator for an AFPM motor according to the present disclosure, each of the odd-layer windings and the even-layer windings may be wound in a wave winding form with five inner end-turns and five outer end-turns, respectively, evenly arranged along the circumferential direction.

In a stator for an AFPM motor according to the present disclosure, the stator core may include 60 slots with a width of 6° and the odd-layer winding and the even-layer winding may each have six windings.

In a stator for an AFPM motor according to the present disclosure, the odd-layer windings and the even-layer windings may each be placed on the stator core with a gap of 6° from each other.

In a for an AFPM motor and the motor including the stator according to the present disclosure, it may be possible to reduce the size of the AFPM motor by reducing the height of the end-turns and to improve the electromagnetic performance of the motor by increasing the designable diameter of the stator.

The methods and apparatuses of the present disclosure have other features and advantages that should be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a perspective view showing a stator for an axial flux permanent magnet (AFPM) motor according to the present disclosure.

FIGS. 2A and 2B are perspective views showing a winding in an odd layer and a winding in an even layer of a motor stator.

FIG. 3 illustrates how to form a double helix structure of a motor stator.

FIG. 4 illustrates the odd-layer and even-layer windings in FIGS. 2A and 2B, respectively, assembled according to how to form a double helix structure.

FIG. 5 is a flow chart showing a process of manufacturing a stator for an AFPM motor according to the present disclosure.

FIGS. 6A and 6B respectively illustrate odd-layer and even-layer windings formed as a wave winding of a motor stator.

FIGS. 7A and 7B respectively illustrate the formed odd-layer and even-layer windings of FIGS. 6A and 6B and arranged to fit the positions of slots.

FIG. 8 shows an entire winding assembly obtained by assembling the odd-layer and even-layer windings of FIGS. 7A and 7B in a double helical structure.

FIG. 9 shows the entire winding assembly of FIG. 8 coupled to a stator core.

FIGS. 10A and 10B show how end-turns of the winding assembly coupled to the stator core of FIG. 9 are formed.

FIG. 11 shows a comparison between a conventional stator and a stator according to an embodiment of the present disclosure.

It may be understood that the appended drawings are not necessarily drawn to scale, presenting a somewhat simplified representation of various features illustrative of the basic principles of the present disclosure. The specific design features of the present disclosure as provided herein, including, for example, specific dimensions, orientations, locations, and shapes, will be determined in part by the particularly intended application and use environment.

In the figures, the same reference numerals refer to the same or equivalent parts of the present disclosure throughout the several figures of the drawings.

### DETAILED DESCRIPTION OF ILLUSTRATIVE EMBODIMENTS

As for embodiments of the present disclosure disclosed below, descriptions of specific structures or functions are provided solely for the purpose of describing the embodiments of the present disclosure. The embodiments of the present disclosure can be carried out in various forms and should not be deemed to be limited to the embodiments described below.

Because the embodiments of the present disclosure can be modified and carried out in various forms, specific embodiments are illustrated in the drawings and described in detail below. However, this is not intended to limit the present disclosure to the specific disclosed forms. The present disclosure should be understood to include all changes, equivalents, and substitutes within the technology and technical scope of the present disclosure.

Ordinal expressions such as “first” and “second” may be used to describe various components, but the components are not limited by the expressions. The expressions are used only for the purpose of distinguishing one component from another. For example, within the scope of the present disclosure, a first component can be referred to as a second component, and, similarly, the second component can also be referred to as the first component.

When a component is said to be “coupled” or “connected” to another component, it means that the component may be directly coupled or connected to the other component or there may be other components therebetween. On the other hand, when a component is referred to as being “directly coupled” or “directly connected” to another component, it means that there are no other components therebetween. Other expressions that describe relationships between components, such as “between . . . ” or “immediately between . . . ” and “adjacent to . . . ” or “directly adjacent to . . . ,” should be interpreted in the same manner. Similarly, the expression “placed on . . . ” means that a certain component is placed directly on the surface of another component or that it is placed on top of another component at a distance from the surface of the other component.

The terms used herein are only used to describe specific embodiments and are not intended to limit the present disclosure. Expressions in the singular form include the meaning of the plural form unless clearly meant otherwise within the context. In the present disclosure, expressions such as “comprise”, “include”, or “have” and variations thereof are intended to indicate the presence of the described features, numbers, steps, operations, components, parts, or combinations thereof. Such expressions should not be understood as precluding the possibility of the presence or the addition of one or more other features, numbers, steps, operations, components, parts, or combinations thereof.

Unless otherwise defined, all terms used herein, including technical or scientific terms, have meanings commonly understood by a person having ordinary skill in the technical field to which the present disclosure pertains. Terms defined in commonly used dictionaries should be interpreted as having meanings consistent with the meanings that the terms have in the context of the relevant technology. Such terms should not be interpreted in an ideal or overly formal sense unless explicitly defined in the present disclosure.

When a component, module, unit, device, element, apparatus, or the like of the present disclosure is described as having a purpose or performing an operation, function, or the like, the component, module, unit, device, element, apparatus, or the like should be considered herein as being “configured to” meet that purpose or to perform that operation or function.

When an embodiment can be carried out in a different way, functions or operations specified in a specific block can occur in an order different from the order specified in a flowchart. For example, functions or operations specified in two consecutive blocks may actually be performed substantially simultaneously, or may be performed in a reverse order.

Hereinafter, a stator for an axial motor and a motor including the same according to the present disclosure are described with reference to the attached drawings.

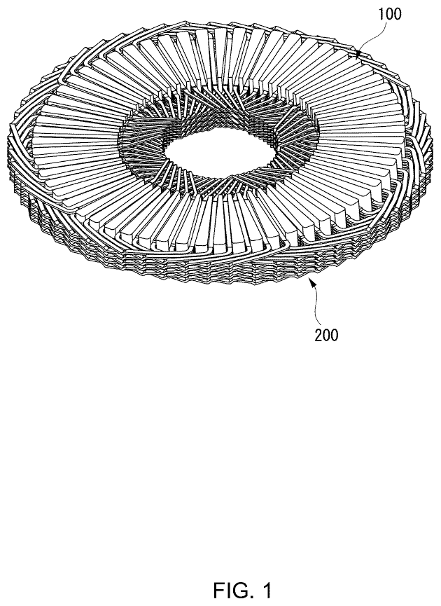

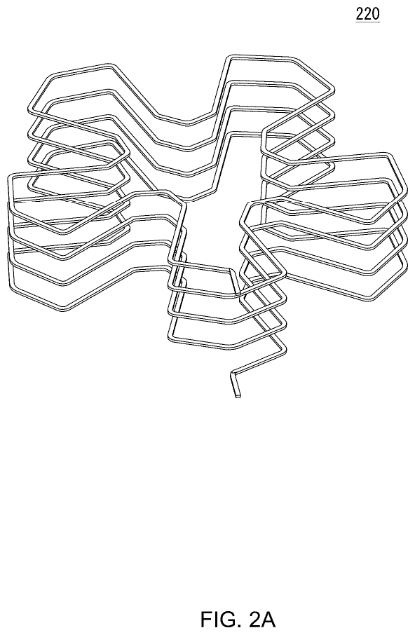

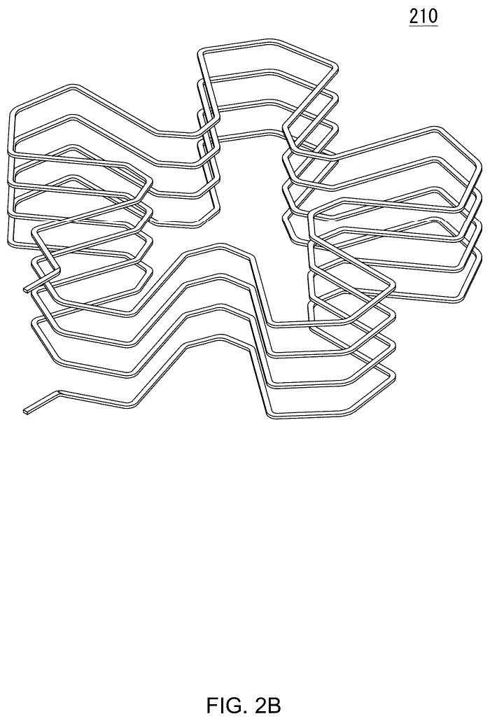

FIG. 1 is a perspective view showing a stator for an axial flux permanent magnet (AFPM) motor according to the present disclosure. FIGS. 2A and 2B are perspective views showing a winding in an odd layer and a winding in an even layer of the stator.

The stator for the AFPM motor according to the present disclosure may include a plurality of coils 200 wound around a stator core 100. The stator core 100 may include a predetermined number of slots in the circumferential direction. The coils 200 may include odd-layer windings 210 and even-layer windings 220 made of a copper material.

The coils 200 of the stator for the AFPM motor according to the present disclosure may be coupled to the stator core 100 by the odd-layer windings 210 and the even-layer windings 220 that alternately rotate around the inner and outer sides of the stator core 100 along the slots of the stator core 100 to form a double helix structure.

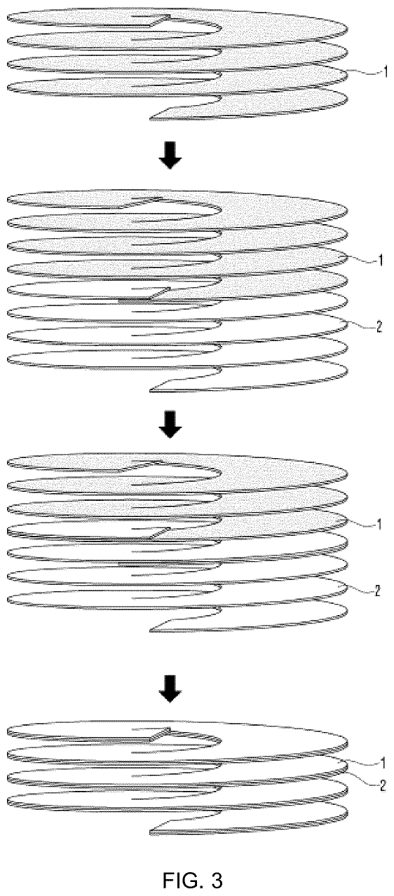

FIG. 3 illustrates how to form a double helix structure. The double helix structure is a structure in which two symmetrical strands are twisted like a rope. In other words, it is a structure in which two windings 1 and 2 having a twisted shape like a conch shell in a helical structure form a double helix. For example, when a second winding 2 of a helical shape is overlapped with a first winding 1 that also has a helical shape from the bottom of the first winding 1 and is rotated counterclockwise, the second winding 2 may overlap the surface of the first winding 1.

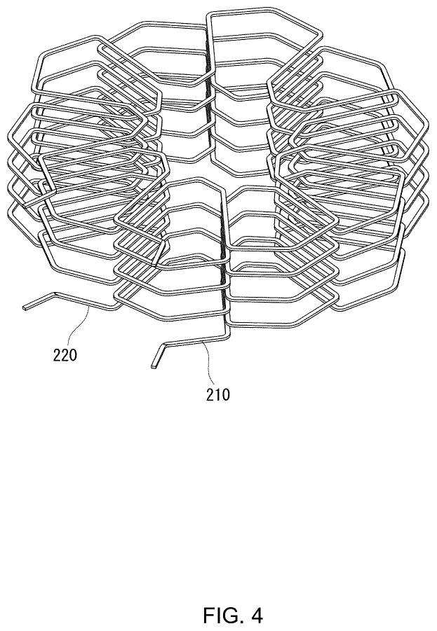

FIG. 4 illustrates the odd-layer and even-layer windings in FIGS. 2A and 2B, respectively, assembled according to how to form a double helix structure. As shown in FIG. 4, the even-layer winding 220 in the same shape as the odd-layer winding 210 may be overlapped on the odd-layer winding 210 and then rotated to form a double helix structure.

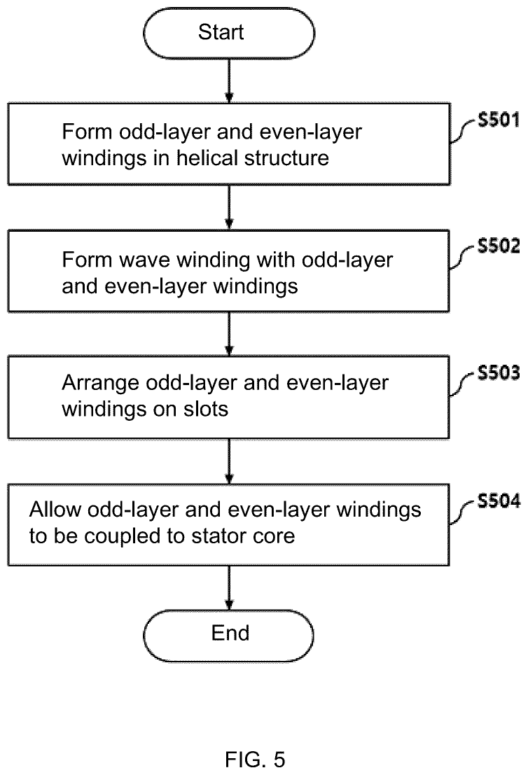

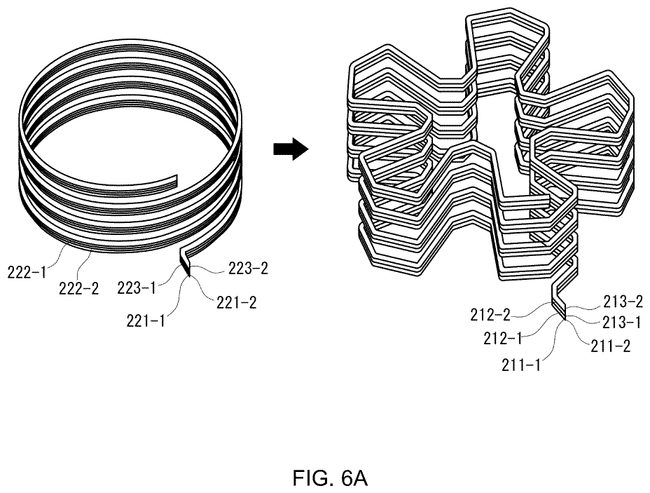

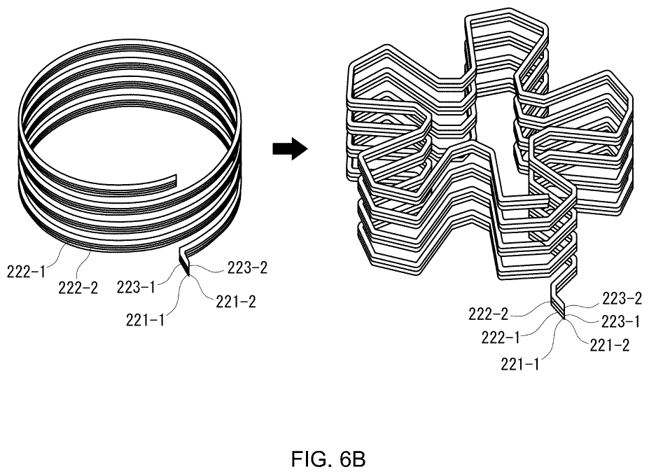

FIG. 5 is a flow chart showing a process of manufacturing the stator for the AFPM motor according to the present disclosure. First, the odd-layer and even-layer helical windings may be manufactured based on the number of the slots formed in the circumferential direction and on the number of turns. FIGS. 6A and 6B respectively illustrate the odd-layer and even-layer windings. A circular shape in a helical structure may be created to suit how to wind. The coil used for the stator for the AFPM motor according to one embodiment of the present disclosure may include a winding in a 10-pole 60-slot helical structure of a three-phase motor. This is only one of various possible embodiments. The present disclosure should not be deemed limited to such an embodiment. The periodicity and angularity of the coil used for the stator for the AFPM motor according to the present disclosure may vary depending on the number of the slots in the motor.

In addition, in the embodiment of the coil used for the stator for the AFPM motor, the double helix structure with the even-layer and odd-layer windings has been described. However, this is only one of many possible embodiments. The coil may also have a multi-helical structure with several windings twisted together.

At S501, the odd-layer winding 210 and the even-layer winding 220 may each have three layers. The winding in each layer may include a lower-layer winding and an upper-layer winding forming a total of six windings in a helical structure. For example, an odd-layer first-layer lower-layer winding 211-1 may be placed at the bottom of the odd-layer winding 210, and a first-layer upper-layer winding 211-2 may be placed above it. An odd-layer second layer 212 may have a lower-layer winding 212-1 and an upper-layer winding 212-2. An odd-layer third layer 213 may have a lower-layer winding 213-1 and an upper-layer winding 213-2. Likewise, the even-layer winding 220 may also have three layers. The winding in each layer may include a lower-layer winding and an upper-layer winding. For example, a first-layer lower-layer winding 221-1 may be placed at the bottom of the even-layer winding 220, and a first-layer upper-layer winding 221-2 may be placed above it. A second layer 222 may have a lower-layer winding 222-1 and an upper-layer winding 222-2. A third layer 223 may have a lower-layer winding 223-1 and an upper-layer winding 223-2.

At S502, the odd-layer and even-layer windings in the helical shape may be wavily wound in a shape, i.e., a wavy shape, similar to a petal or a star. In other words, the windings of the coil may have a radial shape. For example, each single winding strand of the coil used for the stator for the AFPM motor according to the present disclosure may form a wave winding in a pentagonal shape with a periodicity of 72°.

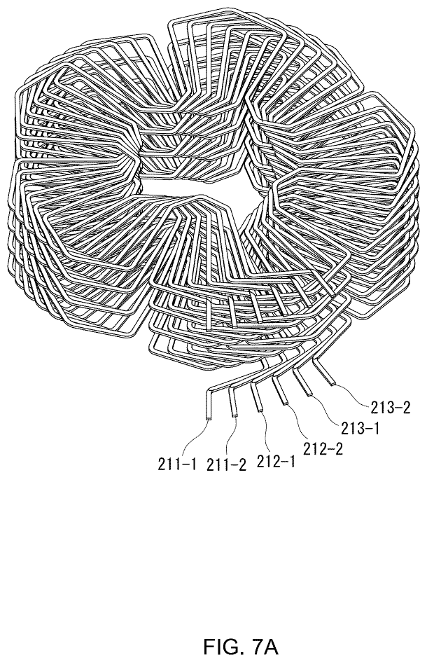

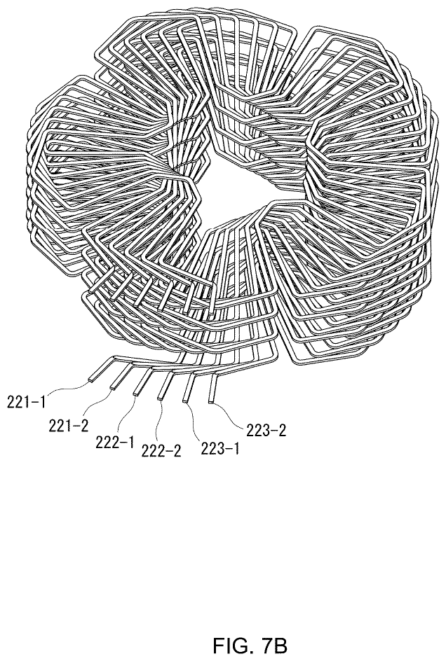

Next, the odd-layer and even-layer windings, which have been formed, may be arranged to fit the positions of the slots as shown in FIGS. 7A and 7B. Since the stator 100 may have 60 slots formed in the circumferential direction and the width of each slot may thus be 6°, the odd-layer and even-layer windings 210 and 220 may each be arranged with a gap, i.e., a circumferential spacing, of 6° from each other.

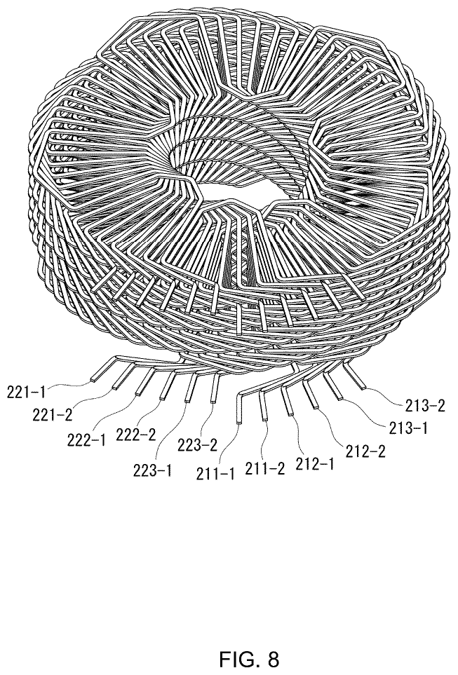

At S503, when the arrangement of each of the odd-layer and even-layer windings has been completed, they may be assembled in a double helical structure as shown in FIG. 8 to complete the entire winding assembly.

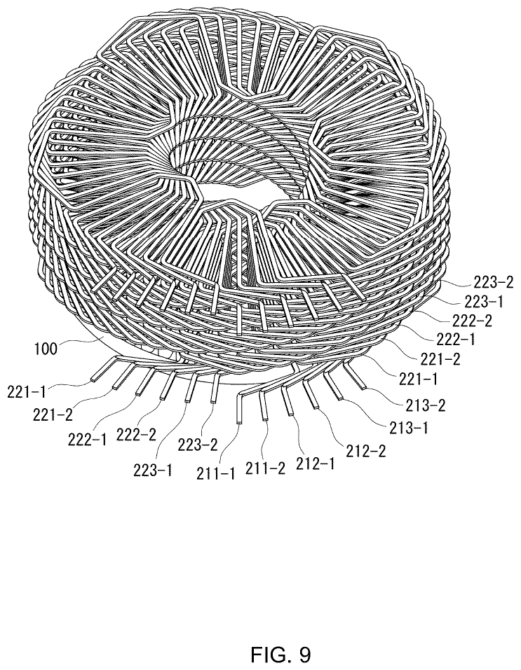

Then, as shown in FIG. 9, the entire winding assembly may be coupled to the stator core 100. Here, the odd-layer winding 210 and the even-layer winding 220 may be coupled to the stator core 100 in a double-helix structure.

The windings of the odd-layer winding 210 may be stacked in the following order: the odd-layer first-layer lower-layer winding 211-1→the odd-layer first-layer upper-layer winding 211-2→the odd-layer second-layer lower-layer winding 212-1→the odd-layer second-layer upper-layer winding 212-2→the odd-layer third-layer lower-layer winding 213-1→the odd-layer third-layer upper-layer winding 213-2. In other words, the aforementioned windings may be inserted one by one into the slot of the stator core 100 in the order. Each winding inserted into the slot of the stator core 100 may form an end-turn therein and may then be inserted back into the slot to protrude outwardly from the stator core 100. In the same manner, the even-layer winding 220 may also be coupled to the stator core 100. The windings of the even-layer winding 220 may be stacked in the following order: the even-layer first-layer lower-layer winding 221-1→the even-layer first-layer upper-layer winding 221-2→the even-layer second-layer lower-layer winding 222-1→the even-layer second-layer upper-layer winding 222-2→the even-layer third-layer lower-layer winding 223-1→the even-layer third-layer upper-layer winding 223-2. In other words, the aforementioned windings may be inserted one by one into the slot of the stator core 100 in the order. In the same manner as the odd-layer winding 210, each winding inserted into the slot of the stator core 100 may form an end-turn therein and may then be inserted back into the slot to protrude outwardly from the stator core 100.

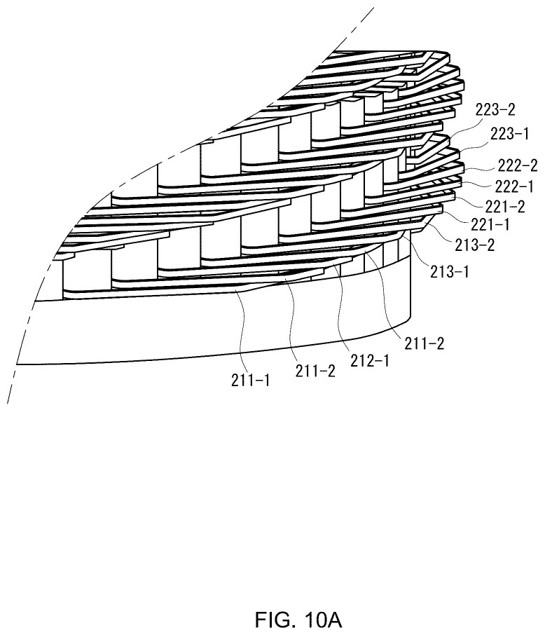

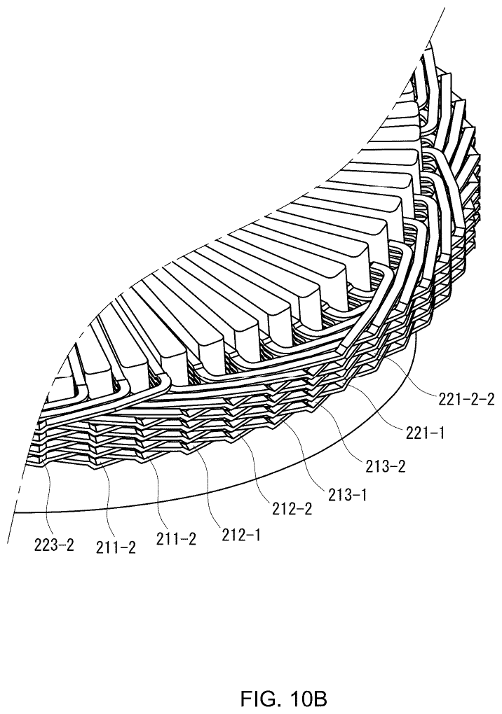

At S504, as shown in FIG. 10A, the windings fully coupled to each other may have the conductors in the same position in the slots and their end-turns may intersect. An additional forming process may be performed to secure a high conductor-occupying ratio. In other words, the end-turns may be formed as shown in FIG. 10B by using the back yoke space according to the shape of the stator core.

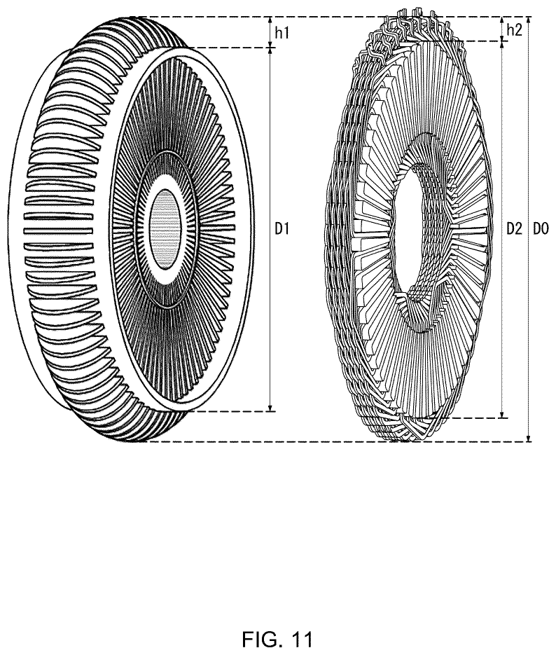

FIG. 11 shows a comparison between a conventional stator (left side view in FIG. 11) and a stator according to an embodiment of the present disclosure (right side view in FIG. 11). As shown in FIG. 11, for the same size diameter D0, the diameter D2 of the stator according to this embodiment may be larger than the diameter D1 of the conventional stator. In addition, it is seen that the radial height h2 of the end-turn portion of the stator according to this embodiment is smaller than the height h1 of the end-turn portion of the conventional stator. That is to say, D2>D1 and h2<h1.

This means that, with the stator according to an embodiment of the present disclosure, it may be possible to obtain a motor that produces greater power than a conventional motor of the same diameter or a motor with a smaller diameter than the conventional motor for the same power.

As described above, a single winding of a coil in a stator for an AFPM motor according to the present disclosure may have a helical structure in the form of a wave winding. Each star-shaped winding rotates the required number of turns along the helix, crossing the inner and outer sides of the stator core. Each star-shaped winding may alternately rotate around the inner and outer sides of the stator core a required number of times along the helix. The odd-layer winding in a helical structure and the even-layer winding in a helical structure, which include multiple single windings, may be assembled in a double helix structure to be connected to the stator core. Therefore, it may be possible to reduce the height of the end-turns when winding coils on the stator for the AFPM motor. It may be possible to improve the electromagnetic performance of the motor by increasing the diameter of the stator of the same size and to manufacture the entire winding at once without a separate process, making it easy to manufacture the entire winding.

The description has been made with reference to embodiments of the present disclosure. However, a person having ordinary skill in the art should understand that various modifications and changes can be made to the embodiments of the present disclosure within the technology and scope of the present disclosure set forth in the flowing claims.

What is claimed is:

1. A stator for an axial flux permanent magnet (AFPM) motor, the stator comprising:
a stator core including a predetermined number of slots in a circumferential direction; and
a plurality of coils inserted into the predetermined number of slots and connected to a multi-phase power supply source,
wherein the plurality of coils includes odd-layer windings and even-layer windings, and
wherein each winding of the odd-layer windings and the even-layer windings wound along the circumferential direction with end-turns thereof alternately disposed at inner and outer sides of the stator core such that the plurality of coils form a multi-helical structure.

2. The stator of claim 1, wherein the plurality of coils is made of copper.

3. The stator of claim 1, wherein the odd-layer windings and the even-layer windings have identical shapes and are arranged such that end-turns thereof alternate.

4. The stator of claim 3, wherein each of the odd-layer windings and the even-layer windings has a helical structure.

5. The stator of claim 4, wherein each of the odd-layer windings and the even-layer windings is wound in a wave winding form with five inner end-turns and five outer end-turns, respectively, evenly arranged along the circumferential direction.

6. The stator of claim 5, wherein the stator core includes 60 slots with a width of 6°, and wherein the odd-layer windings and the even-layer windings each have six windings.

7. The stator of claim 6, wherein the odd-layer windings and the even-layer windings are each placed on the stator core with a gap of 6° from each other.

8. An AFPM motor comprising a stator, wherein:
the stator includes a stator core having a predetermined number of slots in a circumferential direction and having a plurality of coils inserted into the predetermined number of slots;
the plurality of coils includes odd-layer windings and even-layer windings; and
each winding of the odd-layer windings and the even-layer windings are wound along the circumferential direction with end-turns thereof alternately disposed at inner and outer sides of the stator core such that the plurality of coils forms a multi-helical structure.

9. The motor of claim 8, wherein the plurality of coils is made of copper.

10. The motor of claim 8, wherein the odd-layer windings and the even-layer windings have identical shapes and arranged such that end-turns thereof alternate.

11. The motor of claim 10, wherein each of the odd-layer windings and the even-layer windings has a helical structure.

12. The motor of claim 11, wherein each of the odd-layer windings and the even-layer windings is wound in a wave winding form with five inner end-turns and five outer end-turns, respectively, evenly arranged along the circumferential direction.

13. The motor of claim 12, wherein the stator core includes 60 slots with a width of 6°, and wherein the odd-layer windings and the even-layer windings each have six windings.

14. The motor of claim 13, wherein the odd-layer windings and the even-layer windings are each placed on the stator core with a gap of 6° from each other.
